(19) United States
(12) Patent Application Publication
(10) Pub. No.: US 2009/0047561 A1
(43) Pub. Date: Feb. 19, 2009

(54) METHOD OF MAKING FUEL CELL DIFFUSION LAYER AND FUEL CELL DIFFUSION LAYER

(75) Inventor: Nobuo Yodoshi, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA JIDOSHA KABUSHIKI KAISHA, AICHI-KEN (JP)

(21) Appl. No.: 12/158,709

(22) PCT Filed: Dec. 26, 2006
(86) PCT No.: PCT/JP2006/326354

§ 371 Date: Jun. 23, 2008

(30) Foreign Application Priority Data
Dec. 27, 2005 (JP) 2005374879

(51) Int. Cl. H01M 8/10; B05D 5/12; H01M 4/86; H01M 4/88

(52) U.S. Cl. 429/30; 427/115

(57) ABSTRACT

A method of making a fuel cell diffusion layer includes the steps of: (a) preparing an ink by dispersing a carbon powder and an ion conductor in a solvent; and (b) forming the fuel cell diffusion layer by coating the ink on a substrate through an ink-jet process. By so doing, it is possible to impart desired properties to the fuel cell diffusion layer.

### TECHNICAL FIELD

The present invention relates to a method of making a diffusion layer for use in a fuel cell, and to a diffusion layer for use in a fuel cell.

### BACKGROUND ART

A fuel cell, such as a solid polymer type fuel cell, is composed of an alternating stack of separators and MEAs (Membrane Electrode Assembly) that are composed of an electrolyte membrane sandwiched between a cathode electrode and an anode electrode. In a typical arrangement, the cathode electrode and the anode electrode each has a catalyst layer disposed on the side thereof which contacts the electrolyte membrane, and a diffusion layer on the side which contacts the separator.

An oxidant gas containing oxygen is supplied to the cathode electrode via the separator, and the supplied oxidant gas is diffused into the catalyst layer through voids which are formed in the diffusion layer on the cathode side and is used for the reaction given by formula (1) below. A fuel gas containing hydrogen is supplied to the anode electrode via the separator, and the supplied fuel gas is diffused into the catalyst layer through voids which are formed in the diffusion layer on the anode side and is used for the reaction given by formula (2) below. Through these reactions, the fuel cell converts chemical energy of matter directly into electrical energy.

Cathode electrode reaction: 2H⁺+2e⁻+(½)O₂→H₂O (1)

Anode electrode reaction: H₂→2H⁺+2e⁻ (2)

Water generated through the reaction of formula (1) on the cathode electrode is drain out through the voids which are formed in the diffusion layer on the cathode side. At the anode electrode, water for the purpose of smooth diffusion through the electrolyte membrane of the hydrogen ions generated in the reaction of formula (2) is supplied through the voids which are formed in the diffusion layer on the anode side.

From the above, in order for the reaction described above to proceed smoothly in the fuel cell, it is desirable that supply of the oxidant gas and fuel gas (hereinafter collectively termed “reactant gases”) and the supply and drainage of water are taken place smoothly. Therefore, with respect to properties such as permeability to the reactant gases and to water, it is preferable for the diffusion layer on the cathode side and on the anode side (hereinafter collectively termed the “diffusion layers”) to have the desired properties. The properties of the diffusion layer are highly affected by conditions of void formation, namely, placement and size of the voids within the diffusion layer.

Techniques for controlling the conditions of void formation within the diffusion layer by adjusting the size of the carbon particles used to form the diffusion layer, or adjusting the press pressure during the fuel cell manufacturing process, have been disclosed (for example, in JP 2002-367655 A, JP 2004-158446 A, and JP 2004-179156 A).

However, with the prior art techniques mentioned above, fine control of the conditions of void formation within the diffusion layer has proven difficult, and there is a need for further improvement of the properties of the diffusion layer.

This problem is not limited to solid polymer type fuel cells, and is a problem common to diffusion layers for use in fuel cells.

### DISCLOSURE OF THE INVENTION

With a view to addressing the problems of the prior art discussed above, it is an object of the present invention to provide a technique whereby it is possible to impart desired properties to diffusion layers for use in a fuel cell.

In order to address the problem, a method of making a fuel cell diffusion layer of the present invention comprises the steps of:

(a) preparing an ink by dispersing a carbon powder and an ion conductor in a solvent; and

(b) forming the fuel cell diffusion layer by coating the ink on a substrate through an ink-jet process.

This method of making a fuel cell diffusion layer, by virtue of including a step of coating an ink on a substrate through an ink-jet process to form the fuel cell diffusion layer, can impart desired properties to the fuel cell diffusion layer.

In the method of making a fuel cell diffusion layer, the coating of the ink in the step (b) may be carried out on a catalyst layer of the fuel cell as the substrate.

According to this method, good cohesion of the fuel cell diffusion layer with the catalyst layer can be achieved, reducing contact resistance.

In the method of making a fuel cell diffusion layer, a pore-forming agent may be admixed into the ink to be prepared in the step (a), and the method may further comprise the step of (c) forming a plurality of fine pores within the fuel cell diffusion layer by means of the pore-forming agent after coating the ink.

According to this method, permeability to reactant gases and to water within the fuel cell diffusion layer can be improved by the fine pores.

In the method of making a fuel cell diffusion layer, the catalyst layer may be formed by coating through an ink-jet process on the electrolyte layer a catalyst layer ink prepared by dispersing an ion conductor and an electrical conductor supporting a catalyst in a solvent; and may have a plurality of catalyst layer voids defined by zones in which the catalyst layer ink is not coated. The step (b) may include coating the ink exclusively to prescribed zones thereby forming a plurality of diffusion layer voids defined by zones in which the ink is not coated, in such a way that at least some of the plurality of diffusion layer voids and at least some of the plurality of catalyst layer voids are positioned so as to constitute an integral void passing completely through the diffusion layer and the catalyst layer in the direction of thickness.

According to this method, the diffusion layer and the catalyst layer can be given improved permeability to reactant gases and to moisture, particularly in the thickness direction.

In the method of making a fuel cell diffusion layer, the step (b) may include forming the diffusion layer in such a way that a void ratio is progressively higher in sections of the diffusion layer lying closer to a downstream end of flow of gas supplied to the diffusion layer.

According to this method, permeability to reactant gases and to moisture from the upstream end towards the downstream end of the reactant gases can be improved.

In the method of making a fuel cell diffusion layer, the fuel cell may include a grooved separator positioned on the diffusion layer, and the step (b) may include forming the diffusion layer in such a way that a void ratio in sections of the diffusion layer that face lands formed on surface of the grooved separator is higher than a void ratio in sections of the diffusion layer that face grooves formed on surface of the grooved separator.

According to this method, permeability can be improved also in sections of the diffusion layer that face the lands of the separator where permeability to reactant gases and to moisture is relatively low.

In the method of making a fuel cell diffusion layer, the fuel cell may include a grooved separator positioned on the diffusion layer, and the step (b) may include forming the diffusion layer in such a way that, of the plurality of diffusion layer voids, at least some voids at locations facing lands formed on surface of the grooved separator have linear shape along the direction of grooves formed on surface of the grooved separator on the diffusion layer side thereof.

According to this method, permeability, and particularly that in the direction of the separator grooves, can be improved in sections of the diffusion layer which face the lands of the separator where permeability to reactant gases and to moisture is relatively low.

In the method of making a fuel cell diffusion layer, the step (b) may include forming the diffusion layer in such a way that the diffusion layer voids formed with linear shape have continuous linear shape from one end of the diffusion layer to the other.

According to this method, permeability to reactant gases and to moisture along the direction of the separator grooves can be improved in sections of the diffusion layer which face the lands of the separator.

The present invention may be realizes with various aspects, for example, it is possible to realize it with an aspect of a fuel cell and a method of making the same, a fuel cell diffusion layer and a method of making the same, a fuel cell electrode and a method of making the same, or a fuel cell MEA and a method of making the same.

### BRIEF DESCRIPTION OF THE DRAWINGS

FIG. 1 is an illustration depicting in simplified form a configuration of a fuel cell of the embodiment;

FIG. 2 is a flowchart showing a MEA manufacturing process;

FIG. 3 is a flowchart showing a method of forming a catalyst layer through ink-jet coating;

FIG. 4 is a simplified illustration of ink-jet coating;

FIG. 5 is a conceptual illustration of placement of multiple dots formed through ink-jet coating;

FIG. 6 is conceptual illustration of formation of a catalyst layer through repeated execution of ink-jet coating;

FIG. 7 is a simplified illustration depicting an enlarged section of a catalyst layer void-free portion CF within a formed catalyst layer;

FIG. 8 is conceptual illustration depicting in cross section of a diffusion layer formed through repeated execution of ink-jet coating;

FIG. 9 is an illustration depicting in simplified form gas flow-specific control in void formation in a catalyst layer and in a diffusion layer of an MEA;

FIG. 10 is a graph showing measurements of cell voltage in electrical discharge endurance tests; and

FIG. 11 is a graph showing measurements of cross-leakage in electrical discharge endurance tests.

### BEST MODE FOR CARRYING OUT THE INVENTION

The embodiment of the present invention is described below in the following order.

### A. Embodiment:

### B. Performance Evaluation:

### C. Variations:

### A. Embodiment

### A-1. Configuration of Fuel Cell of the Embodiment

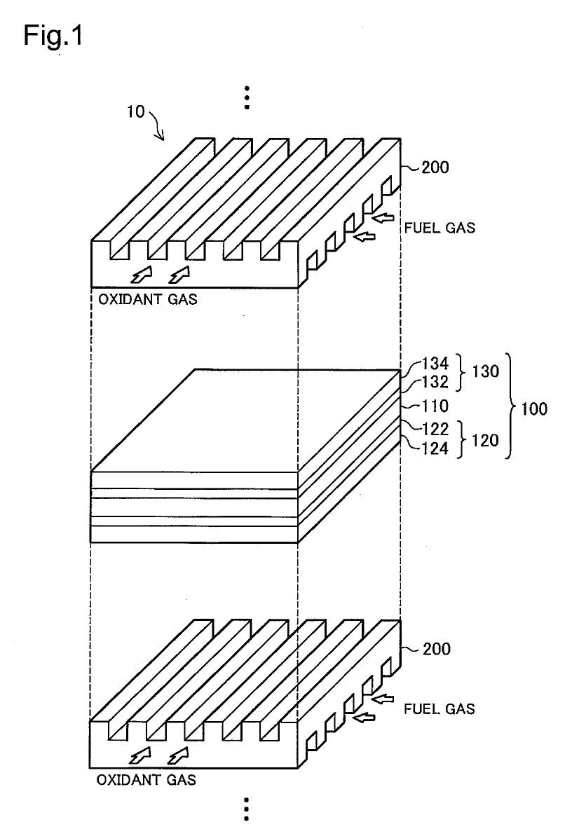

FIG. 1 is an illustration depicting in simplified form a configuration of a fuel cell of the embodiment. The fuel cell 10 is a solid polymer type fuel cell of relatively compact size and excellent power generation efficiency. The fuel cell 10 has a stack structure composed of an MEA 100 sandwiched by separators 200.

The MEA 100 has an electrolyte layer 110; a cathode electrode 120 disposed on one face of the electrolyte layer 110; and an anode electrode 130 disposed on the other face of the electrolyte layer 110. In the description hereinbelow, the cathode electrode 120 and the anode electrode 130 are referred to collectively simply as the “electrodes.”

The electrolyte layer 110 is an ion exchange membrane (e.g. NAFION® by DuPont) made of a polymer material such as fluororesin and has proton conductivity in the wetted condition.

The cathode electrode 120 is the reaction site at which the cathode-side cell reaction (O₂+4e⁻→2O²⁻) proceeds; it includes a cathode catalyst layer 122 adjacent to the electrolyte layer 110, and a cathode diffusion layer 124 adjacent to the separator 200. The anode electrode 130 is the reaction site at which the anode-side cell reaction (2H₂+2O²⁻→2H₂O+4e⁻) proceeds; it includes an anode catalyst layer 132 adjacent to the electrolyte layer 110, and an anode diffusion layer 134 adjacent to the separator 200. The structure of the MEA 100 is discussed in detail later in conjunction with the process for its manufacture.

The separator 200 is formed of material of gas-impermeable dense texture having electrical conductivity. Compression-molded dense-textured carbon, metal, or conductive resin may be used to form the separator 200, for example. The separator 200 is positioned with one face thereof adjacent to the cathode diffusion layer 124 of a first MEA 100, while its other face is positioned adjacent to the anode diffusion layer 134 of another MEA 100. Grooves are formed on either face of the separator 200; once assembled, oxidant gas flow channels are defined between the cathode diffusion layer 124 and the grooves formed on the face contacting the cathode diffusion layer 124, while fuel gas flow channels are defined between the anode diffusion layer 134 and the grooves formed on the face contacting the anode diffusion layer 134. A coolant flow passage may be provided within the separator 200 as well.

While not illustrated in FIG. 1, within the fuel cell 10 and passing through the fuel cell stack in the stacking direction there are additionally provided a fuel gas supply manifold, a fuel gas discharge manifold, an oxidant gas supply manifold, and an oxidant gas discharge manifold. When a fuel gas is supplied to the fuel cell stack, the fuel gas is distributed via the fuel gas supply manifold to the individual fuel gas flow channels and is used for the electrochemical reaction, then subsequently collected by the fuel gas discharge manifold and directed to the outside. When an oxidant gas is supplied to the fuel cell stack, the oxidant gas is distributed via the oxidant gas supply manifold to the individual oxidant gas flow channels and is used for the electrochemical reaction, then subsequently collected by the oxidant gas discharge manifold and directed to the outside. Highly pure hydrogen gas can be used as the fuel gas for example; and air can be used as the oxidant gas for example.

### A-2. MEA Manufacturing Process and Structure

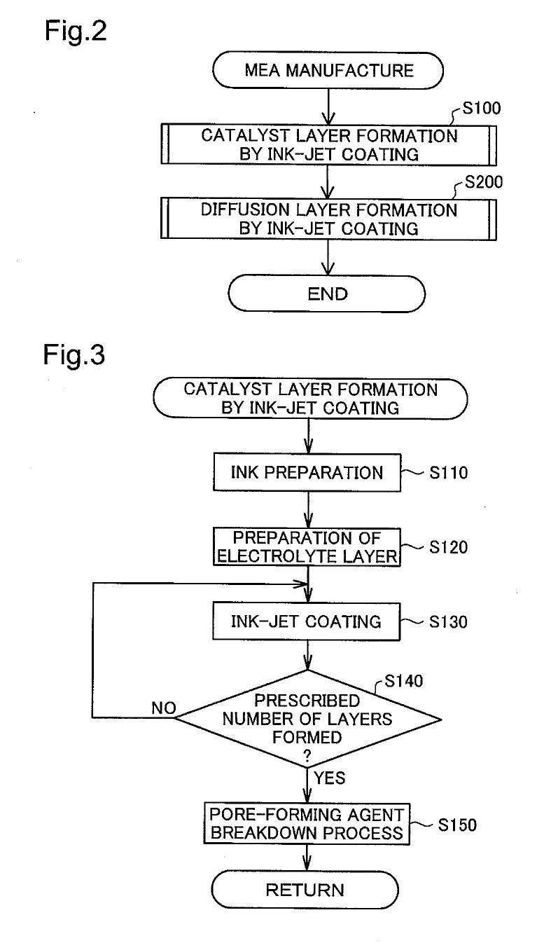

FIG. 2 is a flowchart showing a MEA manufacturing process. In Step S100, the cathode catalyst layer 122 and the anode catalyst layer 132 (hereinafter collectively referred to simply as “catalyst layers”) are formed through ink-jet coating.

FIG. 3 is a flowchart showing a method of forming a catalyst layer through ink-jet coating. When forming the catalyst layers, for example, formation of cathode catalyst layer 122 may be carried out first followed by formation of the anode catalyst layer 132. The formation process and structure of the catalyst layers 122, 132 are basically the same except for different material composition; the following general description notes these differences as needed.

In Step S110, the materials for the catalyst layer (an electrical conductor supporting a catalyst, and an ion conductor) are dispersed in a solvent to prepare a catalyst layer ink. In the embodiment, platinum (Pt) supported on a carbon support (median diameter 0.35 cm; maximum diameter <1 μm) with low impurity content (platinum-supporting carbon) is employed as the catalyst supporting electrical conductor. In the embodiment, the amount of supported platinum is 60 wt % (percentage by weight) for the cathode catalyst layer 122 and 30 wt % for the anode catalyst layer 132. In the embodiment, a 21.3 wt % electrolyte solution (e.g. NAFION aqueous solution) is employed as the proton conductor.

Additionally, a pore-forming agent is mixed into the ink for the catalyst layer, in order to create a catalyst layer that once formed is porous body containing a multitude of fine pores. In the embodiment, the blowing agent VINYFOR AC#3M (fine particulate type: median diameter 3 μm) made by Eiwa Chemical Ind. Co. Ltd. is employed as the pore-forming agent. The compositions and properties of catalyst layer inks containing the above ingredients and solvents are given in Table 1. In Table 1, composition ratios are expressed on a weight basis.

TABLE 1

| | | Cathode catalyst | Anode catalyst |
|---|---|---|---|
| | | layer | layer |
| Composition | Platinum-supporting | 1.0 | 1.0 |
| | carbon | | |
| | Water | 6.3 | 12.2 |
| | Ethanol | 6.3 | 12.2 |
| | Propylene glycol | 1.0 | 2.0 |
| | Electrolyte solution | 1.13 | 3.29 |
| | Blowing agent | 0.05 | 0 |
| Property | Surface tension | 29.3 | 30.0 |
| | (mN/m) | | |
| | Viscosity | 6.0 | 7.0 |
| | (mPa · s) | | |

In Step S120 (FIG. 3), the electrolyte layer 110 is prepared. Specifically, the ion exchange membrane mentioned above is provided as the electrolyte layer 110 and is positioned on a suction platen which has been heated to 40° C., for example. Positioning the electrolyte layer 110 on a heated suction platen inhibits swelling of the electrolyte layer 110 caused by coating of the electrolyte layer 110 with ink in a step to be discussed later.

In Step S130, the prepared electrolyte layer 110 is coated with the catalyst layer ink using an ink-jet coating machine. Conditions for coating in the embodiment are as follows.

### (Ink Jet Coater Coating Conditions)

Nozzle head height: 4 mm
Ink jet head:
   Nozzle count: 96 nozzles/head; nozzle dia. 50 μm
   Ink: 60 pl (picoliters) per drop
Ink ejection frequency: 1.5 KHz
Head advance speed: 60 mm/sec
Resolution (cathode side): Vertical 635 dpi (dots/inch)×Horizontal 300 dpi
Resolution (anode side): Vertical 317.5 dpi×Horizontal 300 dpi

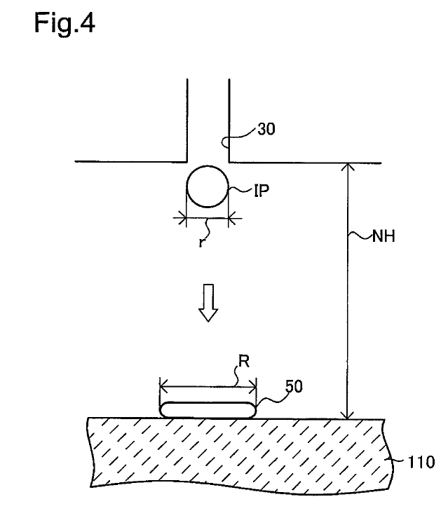

FIG. 4 is a simplified illustration of ink-jet coating. Ink-jet coating is a coating system which involves ejecting fine ink drops IP from nozzles 30 and depositing them on the electrolyte layer 110 to form relatively small dots 50 on the electrolyte layer 110. In this system, the diameter R of the formed dots 50 and the planar placement of the dots 50 can be controlled relatively accurately. Control of diameter R of the dots 50 can be accomplished through adjustment of factors such as the ink drop IP diameter r (the amount of liquid per ink drop), the ink drop IP composition, and the distance NH (nozzle head height) from the nozzle 30 tip to the electrolyte layer 110. In the embodiment, dot diameter R is controlled to between 80 and 100 μm through the use of the ink compositions and coating conditions mentioned previously. Control of the planar placement of the dots 50 can be accomplished through adjustment of ink drop IP ejection location (ejection timing).

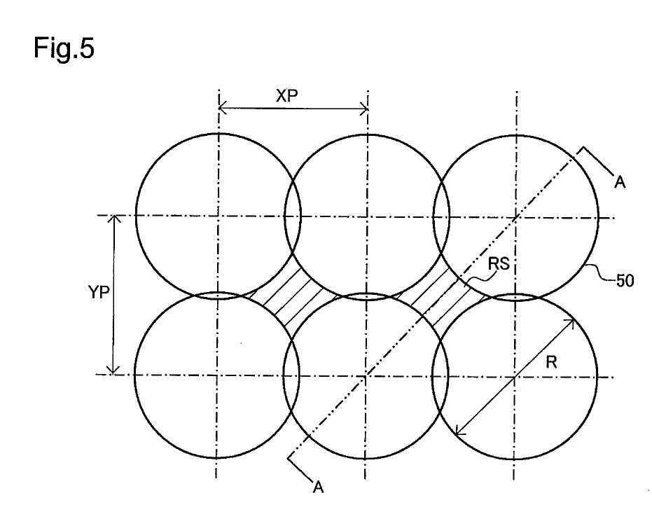

FIG. 5 is a conceptual illustration of placement of multiple dots formed through ink-jet coating. FIG. 5 depicts dots 50 formed on the electrolyte layer 110, viewed in the direction of the arrow in FIG. 4. As shown in FIG. 5, by controlling the diameter R of the dots 50 and the planar placement of the dots 50 (e.g. dot pitch XP in the vertical direction and dot pitch YP in the horizontal direction), the placement of ink application zones in which ink has been applied (i.e. zones in which dots 50 are formed) and of ink non-application zones in which ink has not been applied (hatched zones RS) are controlled. FIG. 5 depicts placement of the dots 50 where the diameter R of the dots 50 is 90 μm, the vertical direction dot pitch XP is 80 μm (equivalent to 317.5 dpi), and the horizontal direction dot pitch YP is 84 μm (equivalent to 300 dpi). That is, the drawing represents placement of the dots 50 under the coating conditions for the anode catalyst layer 132 in the embodiment.

The cathode catalyst layer 122 and the anode catalyst layer 132 are formed through repeated execution of a prescribed number of passes of the ink-jet coating process described above. That is, the ink-jet coating of Step S130 is executed repeatedly until it is determined in Step S140 (FIG. 3) that a prescribed number of layers have been built up.

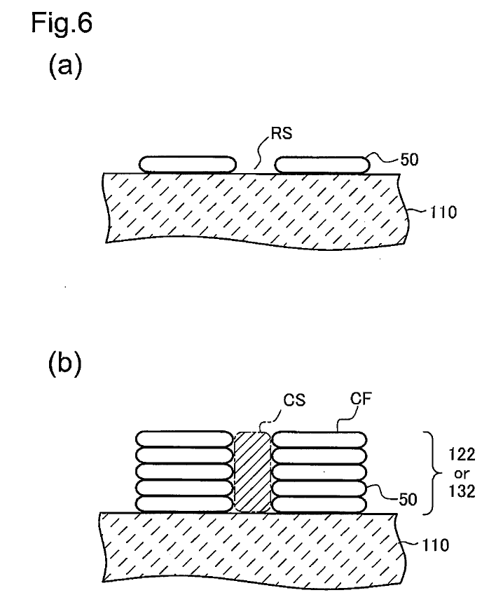

FIG. 6 is conceptual illustration of formation of a catalyst layer through repeated execution of ink-jet coating. FIG. 6 (a) depicts a cross section taken along line A-A in FIG. 5 after ink-jet coating has been carried out one time. FIG. 6 (b) depicts the A-A cross section after ink-jet coating has been repeated five times. As shown in FIG. 6 (b), catalyst layers 122, 132 of desired thickness can be formed by repeatedly carrying out a prescribed number of passes of ink-jet coating. In the embodiment, this prescribed number of passes is nine (i.e. nine layers) for the cathode catalyst layer 122 and five (i.e. five layers) for the anode catalyst layer 132. By repeatedly carrying out ink-jet coating while controlling the diameter R and the planar placement of the dots 50, it is possible to form within the catalyst layer 122, 132 a void CS (hereinafter termed a “catalyst layer void CS”) which passes through the catalyst layer 122, 132 in the thickness direction. This catalyst layer void CS corresponds to a zone defined by multiple layers of ink non-application zones RS in which ink was not applied in the ink-jet coating process described above. Portions of the catalyst layers 122, 132 apart from the catalyst layer void CS are termed “catalyst layer void-free portions CF.”

In Step S150 (FIG. 3), a pore-forming agent breakdown process is carried out. The pore-forming agent breakdown process is a process to break down the pore-forming agent contained in the catalyst layers 122, 132 that were formed through ink-jet coating, in order to form fine pores SH (discussed later) within the catalyst layers 122, 132. In the embodiment, a hot air drying process is carried out at 160° C. for three minutes to bring about thermal breakdown of the blowing agent used as the pore-forming agent. This process has the effect of drying out the catalyst layers 122, 132 in addition to bringing about thermal breakdown of the blowing agent. The pore-forming agent is not limited to a polymer material such as blowing agent, and it would be possible to use other materials. For example, it would be acceptable to use metal powders (e.g. zinc powder) or water-soluble substances (e.g. alcohols such as polyvinyl alcohol, or sugars such as starch) as pore-forming agents. Where a metal powder is employed as a pore-forming agent, the fine pores SH may be created by eluting out the metal powder with an acid (e.g. dilute sulfuric acid). Where a water-soluble substance is employed as a pore-forming agent, the fine pores SH may be created by dissolving out the water-soluble substance with water.

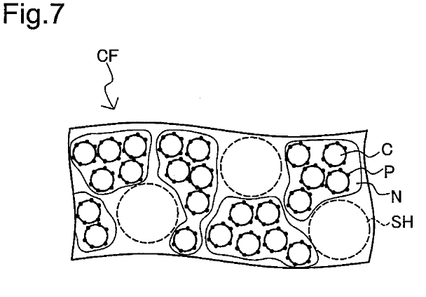

FIG. 7 is a simplified illustration depicting an enlarged section of a catalyst layer void-free portion CF within a formed catalyst layer. A multitude of fine pores SH created by the blowing agent are introduced into the catalyst layer void-free portions CF of the catalyst layers 122, 132. In FIG. 7, N denotes the electrolyte, P denotes the catalyst (platinum), and C denotes the catalyst support (carbon).

According to the method described above, for example, after the cathode catalyst layer 122 has been formed on one face of the electrolyte layer 110, formation of the anode catalyst layer 132 will be carried out on the other face of the electrolyte layer 110 by a similar method. Other properties of the catalyst layers 122, 132 in the embodiment are given below.
Layer thickness: approximately 25 μm
Electrolyte proportion (electrolyte/catalyst support): 0.6 (cathode side), 1.0 (anode side)
Catalyst amount (mg/cm²): 0.45 (cathode side), 0.15 (anode side)

In Step S200 (FIG. 2), formation of the cathode diffusion layer 124 and the anode diffusion layer 134 (hereinafter collectively termed the “diffusion layers”) is carried out through ink-jet coating. The formation method and structure of the diffusion layers 124, 134 are basically similar to the formation method and structure of the catalyst layers 122, 132 described in Step S100. That is, the diffusion layers 124, 134 are produced through a process involving preparation of a diffusion layer ink; coating the diffusion layer ink onto the catalyst layers 122, 132 through ink-jet coating; and carrying out a pore-forming agent breakdown process. When forming the diffusion layers 124, 134, for example, formation of the cathode diffusion layer 124 on the cathode catalyst layer 122 may be carried out first, followed by formation of the anode diffusion layer 134 on the anode catalyst layer 132. The following discussion of the formation method and structure of the diffusion layers 124, 134 will focus exclusively upon the differences from the catalyst layers 122, 132 in the previous discussion.

In the embodiment, the composition and properties of the diffusion layer ink used to form the diffusion layers 124, 134 differ from those of the catalyst layer inks. The composition and properties of the diffusion layer ink are given in Table 2. In Table 2, composition ratios are expressed on a weight basis.

TABLE 2

| | | Diffusion layer |
|---|---|---|
| Composition | Carbon powder | 5.0 |
| | PTFE fine powder | 55.0 |
| | Nonionic stabilizer | 5.0 |
| | Ion water | 30.0 |
| | Electrolyte solution | 5.0 |
| | Blowing agent | 0.3 |
| Property | Surface tension | 30.0 |
| | (mN/m) | |
| | Viscosity | 15.0 |
| | (mPa · s) | |

The diffusion layers 124, 134 also differ from the catalyst layers 122, 132 in that they are formed through repeated execution of ink-jet coating onto the catalyst layers 122, 132 which have been previously formed on the electrolyte layer 110. For formation of the diffusion layers 124, 134, carbon powder of 0.25 μm median diameter is used, and a 20.0 wt % electrolyte solution is used as the ion conductor.

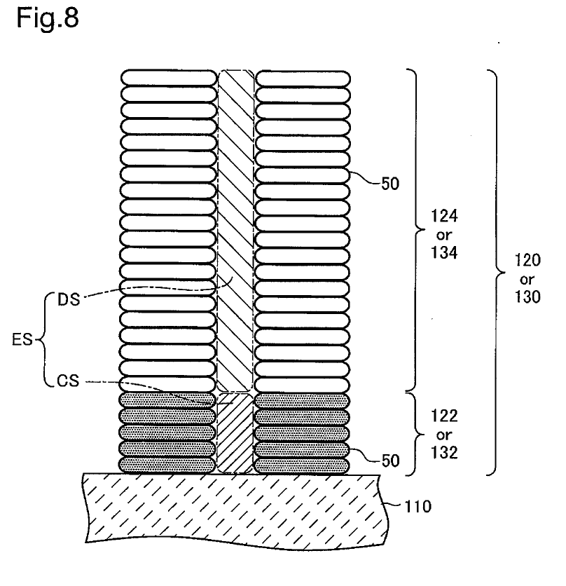

FIG. 8 is conceptual illustration depicting in cross section of a diffusion layer formed through repeated execution of ink-jet coating. FIG. 8 depicts the cross section shown in FIG. 6 (b), shown in a condition after formation of the diffusion layer 124 or 134. As shown in FIG. 8, the diffusion layer 124 or 134 of the desired thickness can be formed through repeated execution of a prescribed number of passes of ink-jet coating. In the embodiment, for both the cathode diffusion layer 124 and the anode diffusion layer 134, the number of repeated ink-jet coating passes is 20 (20 layers) and layer thickness is approximately 50 μm. By repeatedly carrying out ink-jet coating while controlling the diameter R and the planar placement of the dots 50, it is possible to form within the diffusion layer 124, 134 a void DS (hereinafter termed a “diffusion layer void DS”) which passes in the thickness direction through the diffusion layer 124, 134. This diffusion layer void DS is positioned at a location such that it communicates with the catalyst layer void CS which has been formed in the catalyst layer 122 or 132 and forms an integral void therewith. Accordingly, within the electrodes 120, 130 constituted by the catalyst layers 122, 132 and the diffusion layers 124, 134, there will be formed a void ES (hereinafter termed the “electrode void ES”) which passes completely through the electrode 120, 130 in the thickness direction.

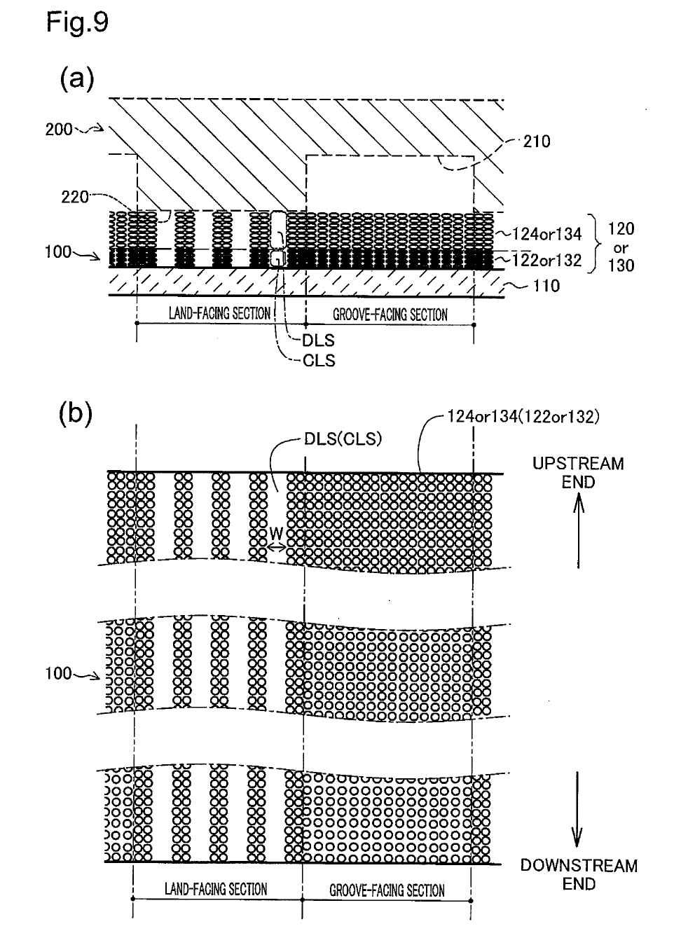

The MEA 100 is manufactured through the method described above. The manufactured MEA 100 includes the electrode voids ES formed within the electrodes 120, 130. In relation to formation of voids in the catalyst layers 122, 132 and in the diffusion layers 124, 134, the MEA 100 of the embodiment further undergoes control specific to reactant gas flows (hereinafter termed “gas-specific control”) carried out in the manner described below. FIG. 9 is an illustration depicting in simplified form gas flow-specific control in void formation in a catalyst layer and in a diffusion layer of an MEA. FIG. 9 (a) is a fragmentary sectional view of the MEA 100, and FIG. 9 (b) is a fragmentary plan view of the MEA 100 viewed from the diffusion layer 124 or 134 side. Here, as shown in FIG. 9, sections of the MEA 100 which face grooves 210 that are formed on the surface of the separator 200 are termed “groove-facing sections,” while sections of the MEA 100 which face lands 220 between the grooves of the separator 200 are termed “land-facing sections.”

In the embodiment, gas-specific control involves control such that the voids in the catalyst layers 122, 132 and in the diffusion layers 124, 134 of the MEA 100 respectively have the following three properties. First, the catalyst layers 122, 132 and the diffusion layers 124, 134 respectively have a void ratio in the sections thereof located in land-facing sections which is greater than the void ratio in sections located in groove-facing sections. Herein, void ratio refers to the proportion of volume of voids within the catalyst layer 122, 132 (or the diffusion layer 124, 134) with respect to the volume of the catalyst layer 122, 132 (or the diffusion layer 124, 134). Control of the void ratio of the catalyst layers 122, 132 and in the diffusion layers 124, 134 can be accomplished by changing the size of the voids, or by changing the void placement density.

Secondly, the catalyst layers 122, 132 and the diffusion layers 124, 134 in sections thereof located in land-facing sections each has voids of linear shape extending in the direction of the grooves of the separator 200. As shown in FIG. 9 (a), voids DLS of linear shape formed in the diffusion layers 124, 134 (hereinafter termed “diffusion layer linear voids DLS”) communicate with voids CLS of linear shape formed in the catalyst layers 122, 132 (hereinafter termed “catalyst layer linear voids CLS”) to form integral voids of linear shape. As shown in FIG. 9 (b), the diffusion layer linear voids DLS and the catalyst layer linear voids CLS are formed with continuous linear shape extending from one end to the other through the diffusion layers 124, 134 and the catalyst layers 122, 132. In the embodiment, the width of the diffusion layer linear voids DLS and the catalyst layer linear voids CLS are set to between about 100 and 200 μm.

Thirdly, as shown in FIG. 9 (b), the catalyst layers 122, 132 and the diffusion layers 124, 134 in sections thereof located in groove-facing sections each has progressively higher void ratio in those sections situated closer to the downstream end of the reactant gas flow (sections closer to the bottom in FIG. 9 (b)) along the direction of the grooves of the separator 200. As noted, control of the void ratio of the catalyst layers 122, 132 and in the diffusion layers 124, 134 can be accomplished by changing the size of the voids, or by changing the void placement density.

As explained above, the catalyst layers 122, 132 and the diffusion layers 124, 134 of the fuel cell 10 of the embodiment each has, in addition to fine pores SH, catalyst layer voids CS which pass through the catalyst layer in its thickness direction, and diffusion layer voids DS which pass through the catalyst layer in its thickness direction. For this reason, permeability to the reactant gases and to moisture (both generated water and moisture for humidifying the electrolyte layer 110) is good, particularly in the thickness direction. Furthermore, since the diffusion layer voids DS are situated at locations so as to communicate with the catalyst layer voids CS, electrode voids ES which pass completely through the electrodes 120, 130 in the thickness direction are formed, further improving permeability to the reactant gases and to moisture. Consequently, the electrodes 120, 130 are well supplied with the reactant gases, and it is possible to prevent both drying out of the electrolyte layer 110 due to insufficient moisture, and flooding due to excessive moisture. The performance of the fuel cell 10 can be improved as a result.

Moreover, the catalyst layers 122, 132 and the diffusion layers 124, 134 of the fuel cell 10 of the embodiment in sections located in land-facing sections thereof each have a void ratio which is greater than the void ratio in sections located in groove-facing sections. For this reason, good permeability is achieved in sections of the catalyst layers 122, 132 and the diffusion layers 124, 134 located in land-facing sections, where permeability to the reactant gases and to moisture tends to be relatively low. The performance of the fuel cell 10 can be improved as a result.

Furthermore, the catalyst layers 122, 132 and the diffusion layers 124, 134 of the fuel cell 10 of the embodiment in sections located in land-facing sections thereof each have voids of linear shape extending in the direction of the grooves of the separator 200. For this reason, permeability to the reactant gases and to moisture in sections located in the land-facing sections of the catalyst layers 122, 132 and the diffusion layers 124, 134 is good, particularly in the direction of the grooves of the separator 200. The performance of the fuel cell 10 can be improved further as a result. Also, since the linear voids are formed with continuous linear shape extending from one end to the other through the diffusion layers 124, 134 and the catalyst layers 122, 132, permeability to the reactant gases and to moisture in the catalyst layers 122, 132 and in the diffusion layers 124, 134 can be improved.

Additionally, the catalyst layers 122, 132 and the diffusion layers 124, 134 of the fuel cell 10 of the embodiment, in sections located in groove-facing sections thereof, each have progressively higher void ratio in sections closer to the downstream end of the reactant gas flow along the direction of the grooves of the separator 200. For this reason, in groove-facing sections of the catalyst layers 122, 132 and the diffusion layers 124, 134, permeability to the reactant gases and to moisture flowing from the upstream end towards the downstream end is good. The performance of the fuel cell 10 can be improved as a result.

Moreover, in the fuel cell 10 of the embodiment, the catalyst layers 122, 132 and the diffusion layers 124, 134 are manufactured through ink-jet coating, whereby formation of voids in the catalyst layers 122, 132 and in the diffusion layers 124, 134 can be controlled with good accuracy. For this reason, catalyst layers 122, 132 and diffusion layers 124, 134 having the desired properties can be easily obtained. Also, catalyst layers 122, 132 and diffusion layers 124, 134 having the desired thickness can be obtained easily by repeating ink-jet coating for multiple passes.

Furthermore, in the fuel cell 10 of the embodiment, the ink-jet coating process to form the catalyst layers 122, 132 is carried out directly on the electrolyte layer 110, while the ink-jet coating process to form the diffusion layers 124, 134 is carried out directly on the catalyst layers 122, 132. Thus, unlike a process where the catalyst layers 122, 132 and the diffusion layers 124, 134 are formed on another base material then subjected to lamination and hot pressing, there is no need for a heating process or pressure application such as entailed by a hot pressing operation. As a result, the electrolyte layer 110 is not suffer damage, nor is the fine pores SH and the voids in the catalyst layers 122, 132 and the diffusion layers 124, 134 become crushed due to these processes, thus affording a fuel cell 10 with ultra-long life and high performance. In the ink-jet coating process, where the nozzle head height is set to 5 mm or less (as noted, 4 mm in the embodiment), the ink is not dry out appreciably when the ink is deposited, thus affording better cohesion between the electrolyte layer 110 and the catalyst layers 122, 132, and between the catalyst layers 122, 132 and the diffusion layers 124, 134, as compared to the transfer process or spray process described later. Contact resistance of the fuel cell 10 can be reduced as a result, and the performance of the fuel cell 10 can be improved.

### B. Performance Evaluation

The discussion now turns to performance evaluation of the fuel cell pertaining to the embodiment, carried out by the Applicant.

### B-1. Comparative Examples

For the purpose of performance evaluation, four Comparative Example fuel cells (Comparative Examples 1 to 4) were used together with the fuel cell 10 of the Embodiment. The fuel cells of the Comparative Examples each differ from the fuel cell 10 of the Embodiment in terms of the methods for forming the catalyst layers and/or the diffusion layers. The methods for forming the catalyst layers and the diffusion layers in the fuel cell 10 of the Embodiment and in the fuel cells of the Comparative Examples are summarized in Table 3.

TABLE 3

| | Catalyst layers | Diffusion layers |
|---|---|---|
| Embodiment | Ink-jet coating | Ink-jet coating |
| | (with gas-flow specific | (with gas-flow specific |
| | control) | control) |
| Comparative Example | Ink-jet coating | Pressure bonding |
| 1 | (with gas-flow specific | process |
| | control) | |
| Comparative Example | Ink-jet coating | Pressure bonding |
| 2 | (without gas-flow | process |
| | specific control) | |
| Comparative Example | Spray process | Pressure bonding |
| 3 | | process |
| Comparative Example | Transfer process | Pressure bonding |
| 4 | | process |

In the fuel cell of Comparative Example 1, the catalyst layers are formed by the same ink-jet coating process used for the fuel cell 10 of the Embodiment, while the diffusion layers are formed using a known pressure bonding process. Formation of a diffusion layer by a pressure bonding process involves first applying the prepared diffusion layer ink onto a diffusion layer substrate (a carbon substrate etc.) using a die coater machine, and drying/baking it at 350° C. Diffusion layers formed on the diffusion layer substrate in this way are produced for cathode side and for anode side respectively. The electrolyte layer having completed catalyst layers formed thereon is then sandwiched between the cathode and anode diffusion layers so produced, and joined through hot pressing (100° C., 3 MPa, 4 minutes).

In the fuel cell of Comparative Example 2, the catalyst layers are formed using an ink-jet process, but this ink-jet process does not employ gas flow-specific control as in the ink-jet process used for the fuel cell 10 of the Embodiment. Specifically, in the catalyst layers of Comparative Example 2, while voids were formed passing through the catalyst layer in the thickness direction, control specific to the reactant gas flow is not carried out in relation to formation of the voids. The diffusion layers were formed by a known pressure bonding process similar to that in Comparative Example 1 above.

In the fuel cell of Comparative Example 3, the catalyst layers are formed using a known spray process, while the diffusion layers are formed using a known pressure bonding process similar to Comparative Example 1 above. Formation of a catalyst layer by a spray process involves spray application of the prepared catalyst layer ink onto an electrolyte layer which has been positioned on a suction platen heated to 40° C. The cathode catalyst layer and the anode catalyst layer are respectively produced by performing this process on both sides of the electrolyte layer. Spraying conditions for spray application are as follows.

### (Spraying Conditions for Spray Application)

Nozzle head height: 20 mm
Application rate: 600 mm/sec
Discharge pressure: 0.04 MPa
Application pitch: 15 mm
Layer offset: 3 mm
Number of coats: 5 layers

In the fuel cell of Comparative Example 4, the catalyst layers are formed using a known transfer process, while the diffusion layers are formed using a known pressure bonding process similar to Comparative Example 1 above. Formation of a catalyst layer by a transfer process involves first coating the prepared catalyst layer ink onto a transfer sheet (a TEFLON® sheet is used) with a die coater machine, and drying at 100° C. Catalyst layers formed on the transfer sheet in this way are respectively produced for the cathode and anode catalyst layers. The electrolyte layer is then sandwiched between the cathode and anode catalyst layers so produced, and joined through hot pressing (130° C., 4 MPa, 4 minutes).

The composition and properties of the inks used for the catalyst layer transfer process and spray process in Comparative Examples 1 to 4 are given in Table 4. The catalyst (platinum), the catalyst support (carbon), and the electrolyte used in the Comparative Examples are the same as in the Embodiment discussed earlier.

TABLE 4

| | | Transfer process | | Spray process | |
|---|---|---|---|---|---|
| | | Cathode | Anode | Cathode | Anode |
| Ink | Platinum-supporting | 1.0 | 1.0 | 1.0 | 1.0 |
| Composition | carbon | | | | |
| | Water | 5.1 | 5.1 | 4.5 | 4.8 |
| | Ethanol | 4.4 | 4.4 | 6.5 | 6.9 |
| | Propylene glycol | 2.0 | 2.0 | 0 | 0 |
| | Electrolyte solution | 1.40 | 3.29 | 1.13 | 3.29 |
| | Blowing agent | 0 | 0 | 0 | 0 |
| Property | Surface tension | 40.0 | — | — | — |
| | (mN/m) | | | | |
| | Viscosity | 30.0 | — | — | — |
| | (mPa · s) | | | | |

### B-2. Evaluation Content

Electrical discharge endurance evaluation tests were carried out using the fuel cells of the Embodiment and the Comparative Examples. The tests were carried out using fuel cell modules composed of the MEA of the Embodiment and the Comparative Examples, sandwiched from either side between separators. The tests were carried out by operating each fuel cell module at 0.84 A/cm² current density, and measuring the cell voltage (V) and cross-leakage (MPa)

### B-3. Evaluation Results

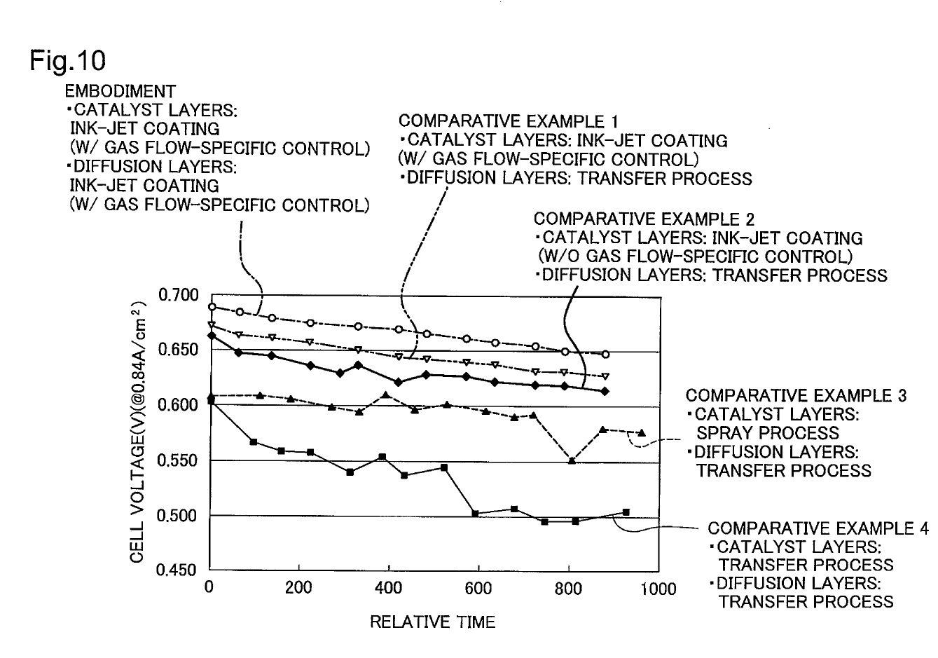

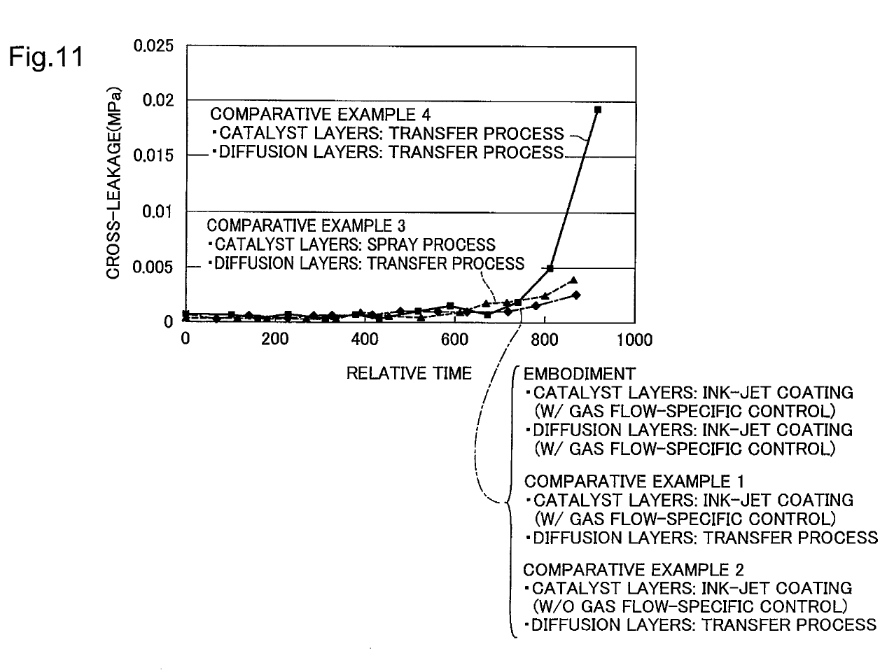

Results of the electrical discharge endurance evaluation tests are shown in FIG. 10 and FIG. 11. FIG. 10 is a graph showing measurements of cell voltage (V) in electrical discharge endurance evaluation tests. FIG. 11 is a graph showing measurements of cross-leakage (MPa) in electrical discharge endurance evaluation tests.

As shown in FIG. 10, when initial cell voltages are compared, the initial cell voltage of the fuel cell module of the Embodiment (approximately 680 mV) is about 20 mV higher than that of the fuel cell module of Comparative Example 1 (approximately 660 mV), indicating higher performance. This is shown to be the effect of improved permeability to the reactant gases and to moisture in the fuel cell module of the Embodiment afforded by the presence of the diffusion layer voids DS formed in the diffusion layers and passing through the diffusion layers in thickness direction, and by gas flow-specific control during void formation. The initial cell voltage of the fuel cell module of Comparative Example 1 is about 10 mV higher than that of the fuel cell module of Comparative Example 2 (approximately 650 mV). This is shown to be the effect of gas flow-specific control during formation of voids in the catalyst layers. The initial cell voltage of the fuel cell module of Comparative Example 2 is about 50 mV higher than that of the fuel cell modules of Comparative Examples 3 and 4 (approximately 600 mV); this is shown to be the effect of improved permeability to the reactant gases and to moisture afforded by the catalyst layer voids CS formed in the catalyst layers.

When cell voltages at relative time of 900 are compared, as shown in FIG. 10, in the same way as with the initial cell voltages the Embodiment (approximately 650 mV) exhibits the highest performance, followed in order by Comparative Example 1 (approximately 620 mV), Comparative Example 2 (approximately 610 mV), Comparative Example 3 (approximately 580 mV), and Comparative Example 4 (approximately 500 mV). In terms of cell voltage at relative time of 900, the fuel cell module of Comparative Example 4 in particular exhibits markedly diminished voltage and degraded performance. This is shown to result from the fact that the fuel cell module of Comparative Example 4 has undergone hot pressing twice, i.e. during catalyst layer formation and during diffusion layer formation, with the electrolyte layer, the catalyst layers, and the diffusion layers experiencing damage due to this hot pressing, resulting in lower durability (cell life).

As shown in FIG. 11, when cross-leakage levels at relative time of 900 are compared, the fuel cell modules of the Embodiment and of Comparative Examples 1 to 3 exhibit good results, i.e. low levels on the order of approximately 0.0025 MPa to 0.0040 MPa. The fuel cell module of Comparative Example 4, on the other hand, exhibits a high level of approximately 0.019 MPa, which greatly exceeds the critical threshold value for cross-leakage (0.01 MPa). As noted, this represents the fact that the electrolyte layer, the catalyst layers, and the diffusion layers have experienced damage, resulting in lower durability (cell life).

### C. Variations

The foregoing description of the present invention based on a preferred embodiment is provided for illustration only and not for the purpose of limiting the invention, and various variations such as the following can be made herein without departing from the scope of the invention.

### C-1. Variation 1

The structure and manufacturing process of the fuel cell 10 of the embodiment are merely exemplary, and it is possible to employ other structures or manufacturing processes. For example, other structures and processes may be employed in relation to the compositions of the catalyst layer and diffusion layer inks, the ink-jet coating parameters, the number of repeated ink-jet coating passes, the shape and placement of voids within the catalyst layers and the diffusion layers, whether or not to use a pore-forming agent, or the shape of the separators. In particular, it is not necessary that all of the voids which have been formed within the diffusion layers pass completely through the diffusion layer in the thickness direction; it is acceptable merely that some of the voids pass completely through the diffusion layer in the thickness direction. Moreover, among the voids within the diffusion layers, it is not necessary that all of the voids which pass through the diffusion layer in the thickness direction communicate with voids passing through the catalyst layer in the thickness direction within the catalyst layers; it is acceptable merely that some of these voids communicate with voids passing through the catalyst layer in the thickness direction. As the catalyst used in the ink it is also possible to use noble metals such as palladium or iridium, or various other metals, alloys, or oxides. With regard the catalyst support, any material of fine powder morphology having electrical conductivity that is not attacked by catalyst are acceptable; graphite, fullerene, or various kinds of metal powders may be used. Various ion conductors may be used as the electrolyte. For example, polymer materials containing carboxylic groups, phosphonic groups, phosphoric groups, or other proton exchange groups may be used.

What is claimed is:

1. A method of making a fuel cell diffusion layer comprising the steps of:
(a) preparing an ink by dispersing a carbon powder and an ion conductor in a solvent; and
(b) forming the fuel cell diffusion layer by coating the ink on a substrate through an ink-jet process, wherein
the coating of the ink in the step (b) is carried out on a catalyst layer of the fuel cell as the substrate,
the catalyst layer is formed by coating through an ink-jet process on an electrolyte layer a catalyst layer ink prepared by dispersing an ion conductor and an electrical conductor supporting a catalyst in a solvent; and has a plurality of catalyst layer voids defined by zones in which the catalyst layer ink is not coated, and
the step (b) includes coating the ink exclusively to prescribed zones thereby forming a plurality of diffusion layer voids defined by zones in which the ink is not coated, in such a way that at least some of the plurality of diffusion layer voids and at least some of the plurality of catalyst layer voids are positioned so as to constitute an integral void passing completely through the diffusion layer and the catalyst layer in the direction of thickness.

2. (canceled)

3. A method of making a fuel cell diffusion layer according to claim 1, wherein
a pore-forming agent is admixed into the ink to be prepared in the step (a), and
the method further comprises the step of (c) forming a plurality of fine pores within the fuel cell diffusion layer by means of the pore-forming agent after coating the ink.

4. (canceled)

5. A method of making a fuel cell diffusion layer according to one of claims 1 or 3, wherein
the step (b) includes forming the diffusion layer in such a way that a void ratio is progressively higher in sections of the diffusion layer lying closer to a downstream end of flow of gas supplied to the diffusion layer.

6. A method of making a fuel cell diffusion layer according to one of claims 1 or 3, wherein
the fuel cell includes a grooved separator positioned on the diffusion layer, and
the step (b) includes forming the diffusion layer in such a way that a void ratio in sections of the diffusion layer that face lands formed on surface of the grooved separator is higher than a void ratio in sections of the diffusion layer that face grooves formed on surface of the grooved separator.

7. A method of making a fuel cell diffusion layer according to one of claims 1 or 3, wherein
the fuel cell includes a grooved separator positioned on the diffusion layer, and
the step (b) includes forming the diffusion layer in such a way that, of the plurality of diffusion layer voids, at least some voids at locations facing lands formed on surface of the grooved separator have linear shape along the direction of grooves formed on surface of the grooved separator on the diffusion layer side thereof.

8. A method of making a fuel cell diffusion layer according to claim 7, wherein
the step (b) includes forming the diffusion layer in such a way that the diffusion layer voids formed with linear shape have continuous linear shape from one end of the diffusion layer to the other.

9. A fuel cell diffusion layer, wherein
the fuel cell diffusion layer is formed by coating an ink on a substrate through an ink-jet process, the ink being prepared by dispersing a carbon powder and an ion conductor in a solvent,
the coating of the ink is carried out on a catalyst layer of the fuel cell as the substrate,
the catalyst layer is formed by coating through an ink-jet process on an electrolyte layer a catalyst layer ink prepared by dispersing an ion conductor and an electrical conductor supporting a catalyst in a solvent; and has a plurality of catalyst layer voids defined by zones in which the catalyst layer ink is not coated, and
the diffusion layer has a plurality of diffusion layer voids formed by coating the ink exclusively to prescribed zones and defined by zones in which the ink is not coated, at least some of the plurality of diffusion layer voids and at least some of the plurality of catalyst layer voids being positioned so as to constitute an integral void passing completely through the diffusion layer and the catalyst layer in the direction of thickness.

10. (canceled)

11. A fuel cell diffusion layer according to claim 9, wherein
the ink includes a pore-forming agent, and
the fuel cell diffusion layer has a plurality of fine pores formed by the pore-forming agent after the coating of the ink.
